(19) United States
(12) Patent Application Publication
(10) Pub. No.: US 2026/0077524 A1
(43) Pub. Date: Mar. 19, 2026

(54) RAZOR HANDLE

(71) Applicant: DORCO CO., LTD., Seoul (KR)

(72) Inventors: Sung Hee SON, Seoul (KR); Jun Soo CHANG, Seoul (KR); Jong Jin JEONG, Seoul (KR)

(21) Appl. No.: 19/399,346

(22) Filed: Nov. 24, 2025

Related U.S. Application Data
(63) Continuation of application No. PCT/KR2024/007023, filed on May 23, 2024.

(30) Foreign Application Priority Data
May 26, 2023 (KR) 10-2023-0068696
Jul. 21, 2023 (KR) 10-2023-0095160

(51) Int. Cl. B26B 21/52; B26B 21/22

(52) U.S. Cl. CPC B26B 21/522; B26B 21/225

(57) ABSTRACT

A razor handle is proposed. The razor handle may include a front portion facing a direction in which a cutting edge of the razor blade is exposed, and a rear portion formed on an opposite side to the front portion. The rear portion may include a first portion and a second portion arranged to be spaced part from each other in a longitudinal direction of the razor handle and capable of coming into contact with the floor. The first portion may include a first contact portion capable of coming into contact with the floor. The second portion may include a second contact portion and a third contact portion arranged to be spaced apart from each other in a widthwise direction and capable of coming into contact with the floor.

### CROSS REFERENCE TO RELATED APPLICATIONS

This is a continuation application of International Patent Application No. PCT/KR2024/007023 filed on May 23, 2024, which claims priority to Korean patent application No. 10-2023-0068696 filed on May 26, 2023 and Korean patent application No. 10-2023-0095160 filed on Jul. 21, 2023, contents of each of which are incorporated herein by reference in their entireties.

### BACKGROUND

### Technical Field

The disclosure relates to a razor handle, and more particularly to a razor handle coupling with a razor cartridge.

### Description of Related Technology

In general, a razor refers to a product for cutting body hair such as fuzz and stubble on a face or body, and includes a razor handle for a grip, and a razor cartridge with a blade that comes into contact with skin to have a shave.

### SUMMARY

One aspect is a razor handle, which can be hygienically and stably placed, and a razor assembly including the same.

The aspects of the disclosure are not limited to those described herein, and other aspects not mentioned herein may become apparent to those skilled in the art from the following description.

Another aspect is a razor handle that supports a razor cartridge including at least one razor blade and is placeable on a floor, the razor handle including: a front portion facing a direction in which a cutting edge of the razor blade is exposed; and a rear portion formed on an opposite side to the front portion, and including a first portion and a second portion arranged to be spaced part from each other in a longitudinal direction of the razor handle and capable of coming into contact with the floor, wherein the first portion includes a first contact portion capable of coming into contact with the floor, the second portion includes a second contact portion and a third contact portion arranged to be spaced apart from each other in a widthwise direction and capable of coming into contact with the floor, and at least a portion of the first portion has a curvature, and the first contact portion is formed at a widthwise center of the at least a portion of the first portion.

Other details of the disclosure are included in the detailed description and the accompanying drawings.

According to the embodiments of the disclosure, the effects are at least as follows.

It is possible to place the razor assembly or the razor handle hygienically and stably.

It is advantageous to dry the razor assembly or the razor handle.

The effects of the disclosure are not limited to those described above, and various other effects are included in the foregoing description.

### BRIEF DESCRIPTION OF THE DRAWINGS

FIG. 1 is a perspective view showing a razor assembly according to an embodiment of the disclosure.

FIG. 2 is a latera view showing a razor assembly according to an embodiment of the disclosure.

FIG. 3 is a rear view showing a razor assembly according to an embodiment of the disclosure.

FIG. 4 is an enlarged view of I in FIG. 3.

FIG. 5 is a cross-sectional view taken along line AA in FIG. 3.

FIG. 6 is an enlarged view of II in FIG. 3.

FIG. 7 is a cross-sectional view taken along line BB in FIG. 3.

FIG. 8 illustrates a first placement state of a razor assembly according to an embodiment of the disclosure.

FIG. 9 illustrates a relative arrangement between a first contact portion, a second contact portion and a third contact portion of a razor assembly according to an embodiment of the disclosure.

FIG. 10 illustrates a second placement state of a razor assembly according to an embodiment of the disclosure.

### DETAILED DESCRIPTION

Typically, a user places a razor on the floor of a shelf or the like after using and washing the razor.

The razor handle is usually narrower than the razor cartridge and shaped like an arc convexly curved in an opposite direction to a cutting edge of the blade. Therefore, to stably place the razor on the floor, a front portion of the razor cartridge, where the cutting edge of the razor blade is directed, and an end portion of the razor handle are in contact with the floor.

However, such a placement method is not hygienic as ventilation is not smooth in a cutting-edge area because the cutting edge of the blade is adjacent to the floor while facing the floor, and the blade is likely to be contaminated or damaged with foreign substances on the floor.

Further, in the case of a razor cartridge with an additional lubricating member provided in the front thereof to come into contact with a user's skin, the lubricating member may be damaged because the lubricating member is in direct contact with the floor when the cartridge is placed with the cutting edge of the blade facing the floor.

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, first, second, i), ii), a), b) and the like terms may be used in describing elements according to embodiments of the disclosure. Such terms are used solely for the purpose of differentiating one element from another, but not limit the substances, the order, sequence, etc. of those elements. Throughout this specification, when a part ‘includes’ or ‘comprises’ an element, the part is meant to further include other elements rather than excluding other elements unless otherwise stated explicitly.

Below, a razor assembly according to an embodiment of the disclosure will be described with reference to the accompanying drawings.

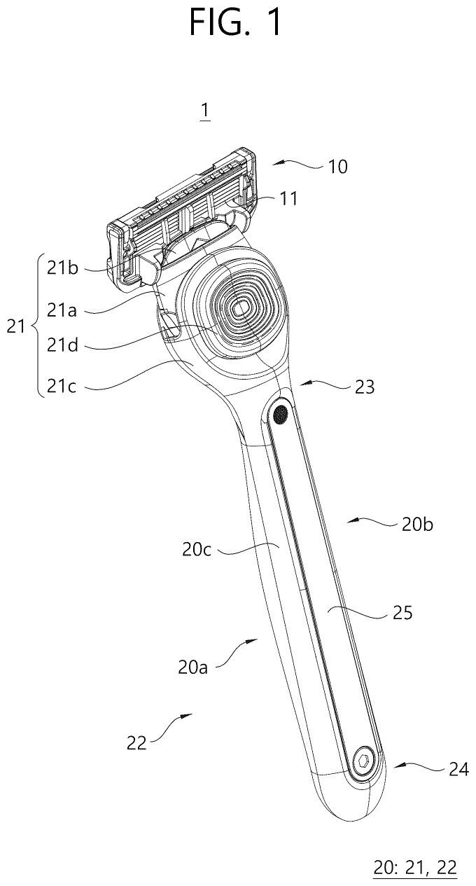

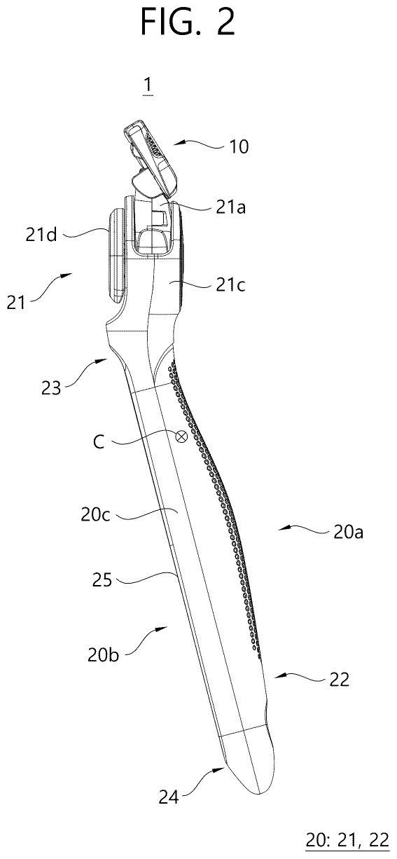

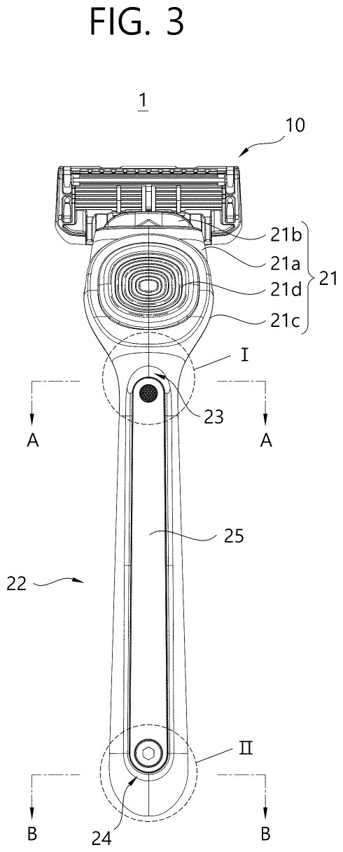

FIG. 1 is a perspective view showing a razor assembly according to an embodiment of the disclosure, FIG. 2 is a latera view showing a razor assembly according to an embodiment of the disclosure, and FIG. 3 is a rear view showing a razor assembly according to an embodiment of the disclosure.

Referring to FIGS. 1 to 3, a razor assembly 1 according to an embodiment of the disclosure includes a razor cartridge 10 and a razor handle 20.

The razor cartridge 10 includes at least one razor blade 11. The cutting edge of the razor blade 11 is exposed frontward. Based on FIG. 2, the right indicates the front, and the left indicates the rear opposite to the front.

The razor handle 20 includes a head portion 21, and a grip portion 22.

The head portion 21 refers to a portion to couple with the razor cartridge 10, and the grip portion 22 refers to a portion to be gripped by a user.

Referring to FIGS. 1 to 3, the head portion 21 may include a connector 21a to couple with the razor cartridge 10, a plunger 21b to provide rotational restoring force to the razor cartridge 10, a housing 21c to support the connector 21a, and an operating portion 21d to separate the razor cartridge 10 from the head portion 21.

[The connector 21a may be detachably coupled to the razor cartridge 10, and support the razor cartridge 10 rotatably within a certain angle range. However, according to an alternative embodiment, the connector 21a may not be detachably coupled to the razor cartridge 10.

The plunger 21b elastically supports the rear of the razor cartridge 10 and provides the restoring force against the rotation of the razor cartridge 10 relative to the connector 21a.

The housing 21c may support the connector 21a rotatably. The rotation axis of the connector 21a relative to the housing 21c may be perpendicular to the rotation axis of the razor cartridge 10 relative to the connector 21a. However, according to an alternative embodiment, the housing 21c may be formed integrally with the connector 21a, or may support the connector 21a irrotatably.

The operating portion 21d may be configured to release the coupling between the connector 21a and the razor cartridge 10 by a user's control. However, according to an alternative embodiment, if the detachable coupling between the connector 21a and the razor cartridge 10 is not intended, the operating portion 21d may be excluded.

The grip portion 22 may be extended from the head portion 21.

Referring to FIGS. 1 and 2, the razor handle 20 may include a front portion 20a, a rear portion 20b, and a lateral portion 20c.

The front portion 20a refers to a portion facing in the same direction as the cutting edge of the razor blade 11 faces, i.e., a portion located on the right side of the razor handle 20 based on FIG. 2.

The rear portion 20b refers to an opposite portion to the front portion 20a, i.e., a portion located on the left side of the razor handle based on FIG. 2. The operating portion 21d may be provided in the rear portion 20b.

The lateral portion 20c may form both lateral sides of the razor handle 20 while connecting the front portion 20a and the rear portion 20b.

Referring to FIGS. 1 to 3, the rear portion 20b includes a first portion 23 and a second portion 24. The first portion 23 and the second portion 24 are arranged to be spaced apart from each other in a longitudinal direction of the razor handle 20. The first portion 23 and the second portion 24 are portions to be in contact with a floor when the razor assembly 1 or the razor handle 20 is placed on the floor with the rear portion 20b facing the floor.

The rear portion 20b may further include a middle portion 25 formed between the first portion 23 and the second portion 24. To make the first portion 23 and the second portion 24 be in contact with the floor and to prevent the middle portion 25 from coming into contact with the floor when the razor assembly 1 or the razor handle 20 is placed on the floor with the rear portion 20b facing the floor, at least one of the first portion 23 and the second portion 24 may protrude more rearward than the middle portion 25.

The first portion 23 may be more adjacent to the razor cartridge 10 than the second portion 24.

When the side of the razor handle 20 adjacent to the razor cartridge 10 is referred to as a front end side and the opposite side is referred to as a rear end side based on the longitudinal direction, the first portion 23 may be located more rearward than the head portion 21. The second portion 24 may be located on the rear end side of the grip portion 22.

Referring to FIG. 2, the center C of gravity of the razor handle 20 may be located at the center of the razor handle 20 in the widthwise direction perpendicular to the longitudinal direction, may be located between the first portion 23 and the second portion 24, and may be more adjacent to the first portion 23 than the second portion 24. Further, the center C of gravity may be located more adjacent to the first portion 20a than the rear portion 20b.

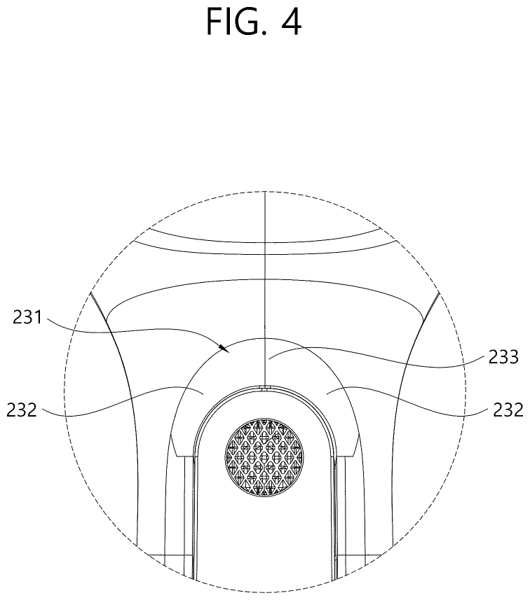

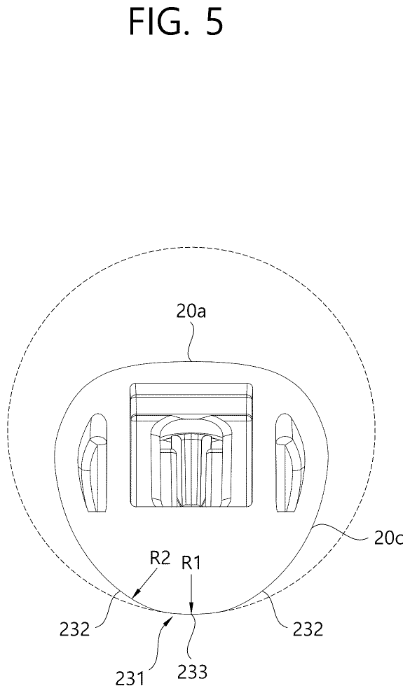

FIG. 4 is an enlarged view of I in FIG. 3, and FIG. 5 is a cross-sectional view taken along line AA in FIG. 3.

Referring to FIGS. 4 and 5, the first portion 23 includes a first central portion 231, and a pair of first extending portions 232 extending from the first central portion 231 toward opposite sides in the widthwise direction. Referring to FIG. 5, the pair of first extending portions 232 may extend on the both sides from the first central portion 231 toward the front portion 20a.

The first central portion 231 includes a first contact portion 233. The first contact portion 233 refers to a portion of the first portion 23, which comes into contact with the floor, when the razor assembly 1 or the razor handle 20 is placed on the floor with the rear portion 20b facing the floor. The first contact portion 233 may be formed at the center of the first portion 23 in the widthwise direction.

Referring to FIG. 5, at least a portion of the first central portion 231 and at least a portion of the first extending portion 232 may be formed to have an outward (convex) curvature. The pair of first extending portions 232 may not be located on the same plane as the first contact portion 233.

The first central portion 231 may be formed to have a first radius R1 of curvature. The dotted line shown in FIG. 5 indicates a circle with the first radius R1 of curvature. The first radius R1 of curvature may be 10 mm to 30 mm.

The first extending portion 232 may be formed inside the circle with the first radius R1 of curvature, so that the first contact portion 233 can be in contact with the floor when the razor assembly 1 or the razor handle 20 is placed on the floor with the rear portion 20b facing the floor. The first contact portion 233 may be in point-or line-contact with the floor. According to an alternative embodiment, the first contact portion 233 may be in surface-contact with the floor.

Referring to FIG. 5, the first extending portion 232 may be formed to have a second radius R2 of curvature. The second radius R2 of curvature may be smaller than the first radius R1 of curvature.

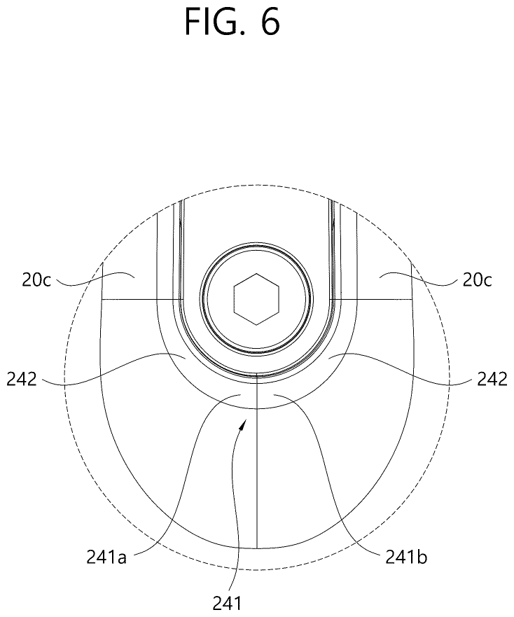

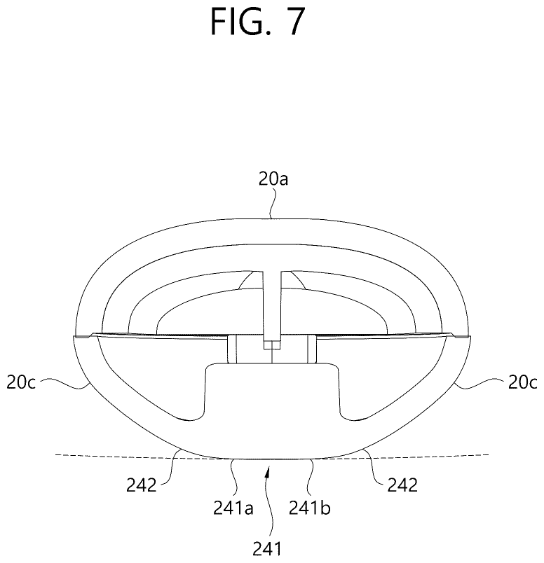

FIG. 6 is an enlarged view of II in FIG. 3, and FIG. 7 is a cross-sectional view taken along line BB in FIG. 3.

Referring to FIGS. 6 and 7, the second portion 24 includes a second central portion 241, and a pair of second extending portions 242 extending from the second central portion 241 toward opposite sides in the widthwise direction. Referring to FIG. 7, the pair of second extending portion 242 may extend on the both sides from the second central portion 241 toward the front portion 20a.

The second central portion 241 includes a second contact portion 241a, and a third contact portion 241b. The second contact portion 241a and the third contact portion 241b refers to a portion of the second portion 24, which comes into contact with the floor, when the razor assembly 1 or the razor handle 20 is placed on the floor with the rear portion 20b facing the floor. In more detail, the second contact portion 241a refers to a region located at one side end in the widthwise direction of the second portion 24 that contacts the floor, and the third contact portion 241b refers to a region located at the opposite side end in the widthwise direction of the second portion 24 that contacts the floor. The second contact portion 241a and the third contact portion 241b may be formed on both sides in the widthwise direction from the center of the second portion 24. The second contact portion 241a and the third contact portion 241b may be located at the same distance in the widthwise direction from the center of the second portion 24 or the center C of gravity.

Referring to FIG. 7, the second extending portions 242 may extend from the second contact portion 241a and the third contact portion 241b on both sides in the widthwise direction, and may extend toward the front portion 20a so as not to be located on a plane connecting the second contact portion 241a and the third contact portion 241b. In other words, the tangent of the second extending portion 242 may be inclined to the plane connecting the second contact portion 241a and the third contact portion 241b.

The second central portion 241 may include a flat or curved surface connecting the second contact portion 241a and the third contact portion 241b, shown as the dotted line in FIG. 7. As shown in FIG. 7, the second extending portion 242 may be formed closer to the front portion 20a than the plane connecting the second contact portion 241a and the third contact portion 241b, or may be formed inside a circle formed by a curved surface connecting the second contact portion 241a and the third contact portion 241b. Accordingly, the second contact portion 241a and the third contact portion 241b may be configured to come into contact with the floor when the razor assembly 1 or the razor handle 20 is placed on the floor with the rear portion 20b facing the floor. The second contact portion 241a and the third contact portion 241b may come into point-, line-or surface-contact with the floor.

An area between the second contact portion 241a and the third contact portion 241b may be spaced apart from the floor so as not to come into contact with the floor. Alternatively, an area between the second contact portion 241a and the third contact portion 241b may come into contact with the floor, and in this case, the second central portion 241 may come into line-or surface-contact with the floor as a whole.

The razor assembly 1 or the razor handle 20 is placed on the floor as the first contact portion 233 of the first portion 23 on the first side in the longitudinal direction is in contact with the floor and the second contact portion 241a and the third contact portion 241b of the second portion 24 on the second side is in contact with the floor. An area where the razor handle 20 is supported on the floor by the second portion 24 may be larger than an area where the razor handle 20 is supported on the floor by the first portion 23.

When the second central portion 241 includes the curved surface connecting the second contact portion 241a and the third contact portion 241b, the radius of curvature the curved surface has maybe larger than the first radius R1 of curvature the first central portion 231 has.

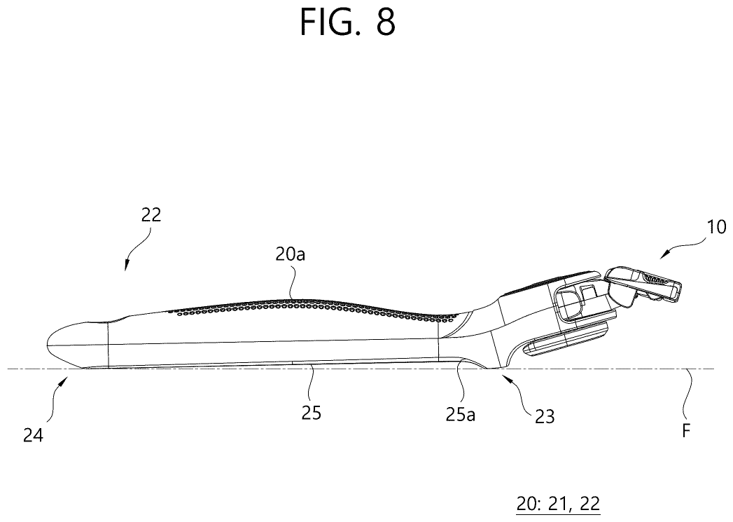

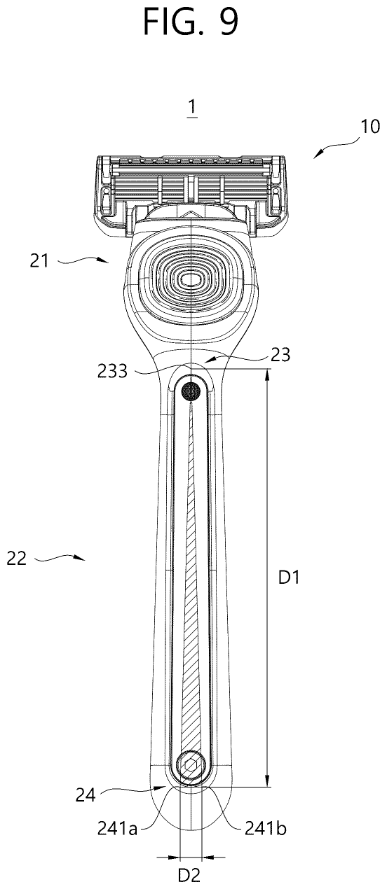

FIG. 8 illustrates a first placement state of a razor assembly according to an embodiment of the disclosure, and FIG. 9 illustrates a relative arrangement between a first contact portion, a second contact portion and a third contact portion of a razor assembly according to an embodiment of the disclosure.

In a first placement state, the razor assembly 1 according to an embodiment of the disclosure is placed on a floor F with the front portion 20a facing upward and the rear portion 20b facing the floor F.

Referring to FIG. 8, the first portion 23 and the second portion 24 of the razor handle 20 are in contact with the floor F. In more detail, the first contact portion 233 of the first portion 23 is in contact with the floor F, and the second contact portion 241a and the third contact portion 241b of the second portion 24 are in contact with the floor F.

Referring to FIG. 9, the first contact portion 233, the second contact portion 241a and the third contact portion 241b are arranged in the form of a triangle, so that the razor assembly 1 can be maintained in the first placement state stably with respect to the floor F.

A distance D1 between the first portion 23 and the second portion 24, a height D1 of the triangle formed by the first contact portion 233, the second contact portion 241a and the third contact portion 241b, or a distance D1 between the first contact portion 233 and a line connecting the second contact portion 241a and the third contact portion 241b may be 60 mm to 100 mm. The length of D1 may be more than 50% of the total length of the razor handle 20, and in this case, the deviation of the razor handle 20 from an axis parallel to the widthwise direction is restricted in the first placement state.

A width D2 between the second contact portion 241a and the third contact portion 241b or a length D2 of the base of the triangle formed by the first contact portion 233, the second contact portion 241a and the third contact portion 241b may be 0.6 mm to 20.0 mm.

The area of the triangle formed by the first contact portion 233, the second contact portion 241a and the third contact portion 241b may be 20 mm2 to 1000 mm2, preferably 20 mm2 to 750 mm2.

The relative arrangement between the first contact portion 233, the second contact portion 241a, the third contact portion 241b, and the center C of gravity may be determined so that the razor handle 20 can hold the first placement state by itself like a roly-poly toy even though a user does not correctly place the razor handle 20 on the floor F in the first placement state.

For example, when the first portion 23 and the second portion 24 of the razor handle 20 are in contact with the floor F, but the first contact portion 233, the second contact portion 241a and/or the third contact portion 241b is not in contact with the floor F, or when the razor handle 20 is placed on the floor F such that the first extending portion 232 or the second extending portion 242 can be in contact with the floor F, the razor handle 20 may rotate by itself to reach the first placement state.

In other words, the razor handle 20 according to this embodiment may rotate by itself to reach the first placement state when the razor handle 20 is put on the floor F as rotated within a certain angle range about a longitudinal axis of the razor handle 20 based on the first placement state.

Due to not only the relative arrangement between the first contact portion 233, the second contact portion 241a, the third contact portion 241b, and the center C of gravity, but also the distinctive shape where the first radius R1 of curvature of the first central portion 231 is larger than the second radius R2 of curvature of the first extending portion 232, the razor handle 20 is easily switched over from a non-first placement state to the first placement state by itself, and stably maintains the first placement state without excessive rotation after reaching the first placement state.

Referring to FIG. 8, in the first placement state, the razor cartridge 10 is spaced apart from the floor F, and the cutting edge of the razor blade faces upward. Accordingly, the cutting edge of the razor blade does not face the floor F or is not adjacent to the floor F, and thus the razor blade is prevented from contamination while the razor assembly 1 is placed on the floor F. Further, it is advantageous to dry the cutting edge compared to the cutting edge facing the floor F, thereby having an effect on preventing the razor blade from rusting. In addition, even though a lubricating member is provided throughout a wide front area of the razor cartridge 10, the lubricating member is completely kept away from the floor F and thus prevented from damage and contamination.

Referring to FIG. 8, in the first placement state, the middle portion 25 formed between the first portion 23 and the second portion 24 may be spaced apart from the floor F. The middle portion 25 may include a slope so that a space can be formed between the middle portion 25 and the floor F in the first placement state. The slope may be formed such that the middle portion 25 keeps away from the floor F as it approaches the head portion 21 of the razor handle 20.

In the slope of the middle portion 25, a top portion 25a, which is most spaced apart from the floor F, may be closer to the first portion 23 than the second portion 24. To this end, the first contact portion 233 may protrude from the middle portion 25 more than the second contact portion 241a and the third contact portion 241b.

Because the middle portion 25 is spaced apart from the floor F in the first placement state, it is advantageous to dry the middle portion 25. In particular, a minimized contact area between the floor F and the rear portion 20b of the razor handle 20 allows the razor handle 20 to be effectively dried even when placed on the floor F because water does not stay in between the razor handle 20 and the floor F when the razor assembly 1 or the razor handle 20 is washed and placed on the floor in a wet state.

As described above, the razor assembly 1 according to an embodiment of the disclosure is stably placed on the floor F in the first placement state in such a manner that three points (i.e., the first contact portion 233, the second contact portion 241a, the third contact portion 241b) of the razor handle 20 are in contact with the floor F, and the front of the razor cartridge 10 faces the direction completely opposite to the floor F.

Further, the minimized contact area between the floor F and the razor assembly 1 is advantageous for drying and hygienic storage of the razor assembly 1.

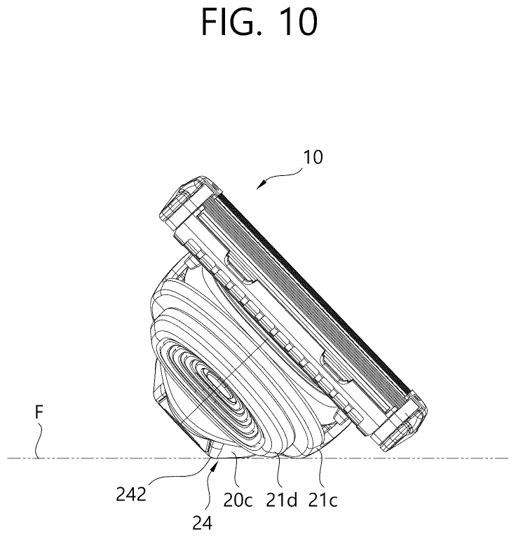

FIG. 10 illustrates a second placement state of a razor assembly according to an embodiment of the disclosure.

Referring to FIG. 10, in the second placement state, the razor assembly 1 according to an embodiment of the disclosure is placed on the floor F with the rear portion 20b slantly facing the floor F.

As described above, the razor assembly 1 or the razor handle 20 may rotate by itself to reach the first placement state when the razor handle 20 is put on the floor F as rotated within a certain angle range from the first placement state. On the other hand, the second placement state refers to a state that the razor handle 20 is placed on the floor F beyond the angle range within which the razor handle 20 can be switched over to the first placement state by itself. In the second placement state, the razor assembly 1 or the razor handle 20 is stably placed on the floor F.

In the second placement state, the second extending portion 242 or the second central portion of the second portion 24 and the housing 21c may be in contact with the floor F. Alternatively, the second extending portion 242 or the second central portion 241 of the second portion 24 and the first extending portion 232 of the first portion 23 may be in contact with the floor F. Alternatively, the lateral portion 20c and the housing 21c may be in contact with the floor F.

Even in the second placement state, the razor assembly 1 according to an embodiment of the disclosure prevents the razor blade from contamination and is advantageous to dry the razor cartridge 10 while being placed on the floor F because the cutting edge of the razor blade does not face the floor F or is not adjacent to the floor F.

Further, according to an embodiment, the razor cartridge may be formed with through holes at both lateral ends thereof to expose both lateral ends of at least one razor blade 11. When the razor assembly with this razor cartridge is placed in the second placement state, one lateral end of the razor cartridge is inclined toward the floor F, and thus water accumulated in the razor cartridge (e.g., water accumulated at both lateral ends of at least one razor blade 11) is discharged through the through holes formed at both lateral ends of the razor cartridge.

Further, the razor assembly 1 according to an embodiment of the disclosure can be in the first placement state or the second placement state so as to be placed on the floor F, and thus a user can place the razor assembly 1 on the floor F in either of the two placement states as desired.

A person having ordinary knowledge in the art to which the disclosure pertains can understood that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor handle that supports a razor cartridge comprising at least one razor blade and is placeable on a floor, the razor handle comprising:
a front portion facing a direction in which a cutting edge of the razor blade is exposed; and
a rear portion formed on an opposite side to the front portion, the rear portion comprising a first portion and a second portion arranged to be spaced part from each other in a longitudinal direction of the razor handle, the rear portion configured to contact the floor, wherein:
the first portion comprises a first contact portion configured to contact the floor, the second portion comprises a second contact portion and a third contact portion arranged to be spaced apart from each other in a widthwise direction and configured to contact the floor, and
at least a portion of the first portion has a curvature, and the first contact portion is formed at a widthwise center of the at least a portion of the first portion.

2. The razor handle of claim 1, wherein, in a state that the first portion and the second portion are in contact with the floor, the second contact portion and the third contact portion are in point-contact, line-contact or surface-contact with the floor.

3. The razor handle of claim 1, wherein, in a state that the first portion and the second portion are in contact with the floor, the first contact portion is in point-contact with the floor.

4. The razor handle of claim 1, wherein:
the first portion comprises a first central portion comprising the first contact portion, and
the second portion comprises a second central portion comprising the second contact portion and the third contact portion.

5. The razor handle of claim 4, wherein a width between the second contact portion and the third contact portion ranges from 0.6 to 20.0 mm.

6. The razor handle of claim 5, wherein:
the first contact portion, the second contact portion and the third contact portion are arranged in a triangular form, and
the arrangement form has an area of 20 mm2 to 1000 mm2.

7. The razor handle of claim 4, wherein the second portion further comprises a pair of second extending portions extending from the second contact portion and the third contact portion in the widthwise direction, and wherein the second extending portion is formed not to be located on the same plane as the second contact portion and the third contact portion.

8. The razor handle of claim 1, wherein the first portion is more adjacent to the razor cartridge than the second portion.

9. The razor handle of claim 8, wherein the center of gravity of the razor handle is located between the first portion and the second portion, and is adjacent to the first portion rather than the second portion.

10. The razor handle of claim 1, wherein:
the first portion comprises a first central portion comprising the first contact portion and formed to have a first radius of curvature, and a pair of first extending portions extending from the first central portion toward opposite sides in the widthwise direction, and
the first radius of curvature ranges from 10 mm to 30 mm.

11. The razor handle of claim 10, wherein the first extending portion has a second radius of curvature, and wherein the second radius of curvature is smaller than the first radius of curvature.

12. The razor handle of claim 1, wherein a distance between the first portion and the second portion ranges from 60 mm to 100 mm.

13. The razor handle of claim 1, wherein:
the rear portion further comprises a middle portion formed between the first portion and the second portion, and
the first portion protrudes more rearward than the middle portion.

14. The razor handle of claim 13, wherein, in a state that the first portion and the second portion are in contact with the floor, the middle portion comprises a slope facing the front portion to form a space between the middle portion and the floor.

15. The razor handle of claim 14, wherein:
a top portion of the slope, which is most spaced apart from the floor, is adjacent to the first portion, and
the first portion is more adjacent to the razor cartridge than the second portion.
